(19) United States
(12) Patent Application Publication
(10) Pub. No.: US 2019/0086240 A1
(43) Pub. Date: Mar. 21, 2019

(54) METHOD AND DEVICE FOR PROCESSING A SIGNAL

(71) Applicant: ROBERT BOSCH GMBH, Stuttgart (DE)

(72) Inventors: Michael UNGERMANN, Darmstadt (DE); Benjamin LECHNER, Neuhausen (DE); Daniel ZIRKEL, Wiernsheim-Serres (DE); Daniel RAICHLE, Vaihingen (DE)

(21) Appl. No.: 15/737,460

(22) PCT Filed: Jun. 7, 2016
(86) PCT No.: PCT/EP2016/062864

§ 371 Date: Dec. 18, 2017

(30) Foreign Application Priority Data
Jun. 18, 2015 (DE) 10 2015 211 247.0

(51) Int. Cl. G01D 5/20; G01D 1/10

(52) U.S. Cl. CPC G01D 5/2073; G01D 1/10; B60L 2220/14; H02P 2203/03; B60L 11/1803

(57) ABSTRACT

The present invention relates to the signal processing of signals with the simultaneous conversion of the operating time grid. To this end, a signal is detected or provided in a first time grid. After the difference quotient is calculated in the first time grid, the difference quotient is output in a second time grid in which the signal, in particular the difference quotient, is further processed.

### BACKGROUND OF THE INVENTION

The present invention relates to a method and a device for processing a signal. In particular, the present invention relates to the processing of a signal with simultaneous conversion of a processing time grid.

Electric and hybrid vehicles are becoming increasingly important. For controlling permanently excited synchronous machines (PSM) and electrically excited synchronous machines (PSM), as are used in such vehicles, knowledge of the rotor position angle of such machines is required. Furthermore, for controlling asynchronous machines (ASM), knowledge of the electrical frequency of the drive is necessary. Various types of sensor may be used for determining the rotor position angle or the electrical frequency. For example, sensors based on the eddy current effect, resolvers or digital angle encoders are possible.

A resolver is in this case excited for example by a preferably sinusoidal carrier signal. Generally obtained as receiver signals of the resolver are disturbed, amplitude-modulated voltages, from the envelope of which the information about the rotor position can be obtained.

German patent application DE 10 2011 078 583 A1 discloses for example an evaluation of resolver sensor signals in a vehicle. To this end, a resolver sensor picks up a rotary movement of a rotor, and a processor element processes the sinusoidal or cosinusoidal output signals of the resolver.

Because of external boundary conditions, it is possible here that a digitized angle signal is provided by an angle signal encoder, such as for example a resolver, within a processor element in a time grid that differs from the time grid for the further processing of the angle signals. For example, the specifications for an integrated component for the evaluation of the output signals from an angle signal encoder may require a computation grid that does not correspond to the computation grid for the further processing of the angle signals.

There is therefore a need for a device and a method for efficient processing of angle signals that have been provided using a variable time grid.

### SUMMARY OF THE INVENTION

According to a first aspect, the present invention provides a device for processing a signal.

Accordingly, the present invention provides a device for processing a signal having a detecting device, a differentiating device and a processing device. The detecting device is designed to detect a signal with a first sampling rate in a first time grid. The differentiating device is designed to differentiate the detected signal and output it in a second time grid. In this case, the differentiating device may differentiate the detected signal in the first time grid. The processing device is designed to subsequently process the differentiated signal in the second time grid. In this case, the time intervals between two signals in the first time grid are smaller than the time intervals of two signals in the second time grid. The signal may be for example an angle signal.

According to a further aspect, the present invention provides a method for processing a signal.

Accordingly, the present invention provides a method for processing a signal having the steps of detecting a signal with a first sampling rate in a first time grid; and differentiating the detected signal. The signal may in this case be differentiated in the first time grid. The method also comprises the steps of outputting the differentiated signal in a second time grid and processing the output differentiated signal in the second time grid. The time intervals of two signal values in the first time grid are in this case smaller than the time intervals of two successive signal values in the second time grid.

The present invention is based on the idea of combining the processing of signals, in particular the filtering of the signals, such as for example angle signals from an angle encoder, at the same time with a changeover of the computation grid. To this end, the signals are detected in the original time grid in which the signals were first provided. This time grid may be prescribed for example by the components for the switching or evaluation of the signals from an angle signal encoder. In particular, such components, such as for example integrated circuits or the like, may be specifically designed only for a particular sampling grid or a predetermined range for a sampling grid. If, however, the further signal processing, such as for example the control of a rotary system, in particular an electrical drive or the like, is intended to take place in a time grid different from that, according to the present invention the changeover from the first time grid, in which the signals are provided, to the second time grid, with which the signals are to be further processed, can take place in the course of the processing of the signals. Such processing of the signals may be for example a filtering of the raw signals. Consequently, the filtering of the raw signals may at the same time bring about a changeover of the time grid.

For the reliable changeover of the computation grid, the input variable does not necessarily have to be sampled significantly faster than the time grid of the output variable requires. It should just be ensured that at least one update of the input variable has taken place between two points in time of the second time grid.

Furthermore, the input variable does not have to be sampled at equidistant increments. Variable increments are also similarly possible, as long as the increment is known.

Since the dynamic component of the processing of the signals after the changeover of the computation grid is processed with a constant sampling increment, approaches of a linear, discrete-time control technology can be used.

According to one embodiment, the processing device comprises a PT1 element. PT elements of a higher order are also similarly possible. Furthermore, further dynamic processings of the signals are likewise possible after the changeover of the computation grid.

According to a further embodiment, the differentiating device is designed to subtract a value of a signal detected by the detecting device from a value that has previously been detected by the detecting device. Furthermore, the differentiating device may divide this difference by the difference between the time intervals of the two detected signals. The change of angle thus calculated can be further used for the further processing and the adaptation of the time grid.

According to a further embodiment, the differentiating device is designed to output the differentiated signal in a second time grid to the processing device. The differentiated signals are consequently adapted to the required time grid for the further processing.

According to a further embodiment, the first sampling grid is variable. In this case, the variable time intervals must be provided at the differentiating device in order to be able to carry out a correct differentiation of the signals. Alternatively, the signal detected by the detecting device may also be detected in a predetermined constant time grid. In this case, the knowledge of the predetermined time grid is sufficient for the differentiation of the signal values.

According to a further embodiment, the step for processing the differentiated signal in the method for processing the signal comprises a low-pass filtering. In addition, any desired further processing steps, in particular any desired filtering steps, are also possible for the processing of the signal. In particular, processing steps that require a definitely prescribed time grid are possible.

According to a further aspect, the present invention provides a drive system having an electrical machine, a rotational angle sensor and a device according to the invention for processing a signal. The electrical machine is in this case coupled to a drive shaft. Furthermore, the rotational angle sensor is coupled to the drive shaft. The rotational angle sensor is also designed to provide a signal corresponding to the angular position of the drive shaft.

According to a further embodiment, the rotational angle sensor comprises a resolver.

Further embodiments and advantages of the present invention will emerge from the following description with reference to the accompanying drawings.

### BRIEF DESCRIPTION OF THE DRAWINGS

FIG. 1 shows a schematic representation of an electrical drive system according to one embodiment;

FIG. 2 shows a schematic representation of a device for processing a signal according to one embodiment; and

FIG. 3 shows a schematic representation of a flow diagram as used as a basis for a method according to one embodiment.

### DETAILED DESCRIPTION

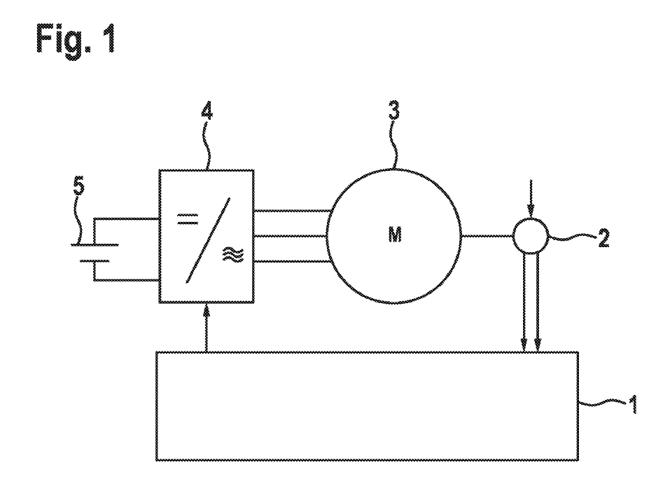

FIG. 1 shows a schematic representation of an electrical drive system according to one embodiment. An electrical machine 3 is fed from an electrical energy source 5 by means of a power converter 4. The electrical energy source 5 may be for example a traction battery of an electric vehicle. The electrical machine 3 may be for example a permanently excited synchronous machine, an electrically excited synchronous machine or else an asynchronous machine. Other electrical machines are also additionally possible in principle. The embodiment represented here of a three-phase electrical machine 3 only represents an embodiment that is given by way of example. Electrical machines with a number of phases other than three are also additionally possible. The power converter 4 converts the electrical energy provided by the electrical energy source 5 and provides the converted electrical energy for the purpose of activating the electrical machine 3. The activation of the electrical machine 3 may in this case be based on defaults or control signals from the control device 1. In addition, when decelerating the electrical machine 3, kinetic energy may also be converted into electrical energy by the electrical machine 3, and this electrical energy may be fed into an electrical energy store of the energy source 5 by means of the power converter 4.

For controlling a permanently or electrically excited synchronous machine, knowledge of the position of the rotor in this machine is required. Furthermore, for controlling asynchronous machines, knowledge of the speed of such a machine is necessary. To this end, the electrical machine 3 may be coupled to a rotary encoder 2. For example, the rotary encoder 2 may be coupled to the drive shaft of the electrical machine 3. Sensors based on the eddy current effect, digital angle encoders or so-called resolvers are possible for example for determining the rotor position and/or the speed of the machine 3.

In a resolver, two sensor windings electrically offset by 90° are generally arranged in a housing. Various alternatives for determining the angular position are possible in principle, one possibility of which is described below by way of example. A further exciter winding of the resolver may for example be excited by a sinusoidal AC voltage. The amplitudes of the voltages induced in the two sensor windings of the resolver are in this case dependent on the angular position of the rotor and correspond to the sine and the cosine of the angular position of the rotor. Consequently, the angular position of the rotor can be calculated from the arctangent (arctan) of the signals of the two sensor windings of the resolver.

The angular position of the rotor may also be additionally detected and provided by any desired further rotor position sensors. For example, position sensors that use an eddy current or digital position signals are also possible.

Furthermore, the present invention is not restricted to angle signals from an angle position encoder, but may also be applied to any desired further signals, in particular to further angle-based signals. An application of the principle according to the invention to any desired signal profiles that are provided or detected in a first time grid and are subsequently to be further processed in a second, predetermined time grid is possible in principle. The following description with reference to angle signals therefore does not represent a restriction, but is just intended to serve for better understanding of the invention.

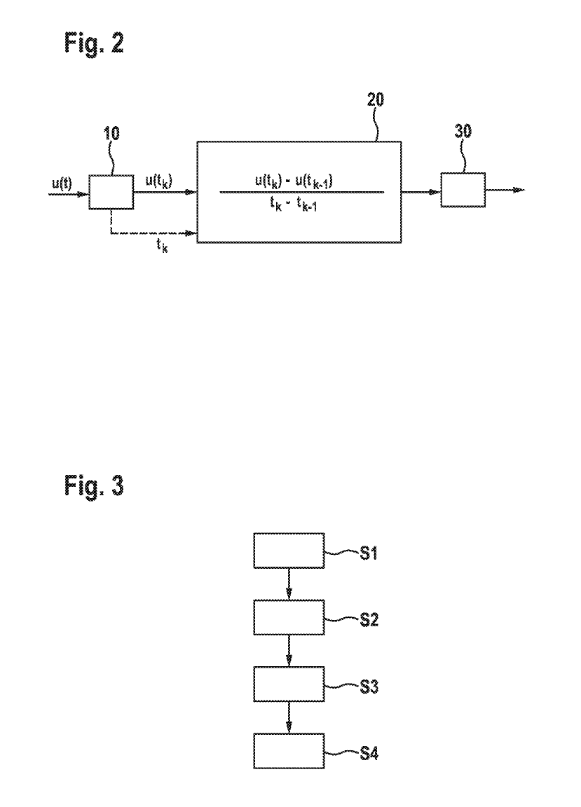

FIG. 2 shows a schematic representation of an exemplary embodiment of a device for processing a signal profile. First, a signal profile, for example a signal profile of an angle signal, is detected by a detecting device 10. The detection of this signal profile takes place in this case at a first sampling rate according to a first time grid. The detecting device 10 may be for example an analog-digital converter, which samples a continuous input signal at points in time according to the first time grid and converts these sampled signal values into digital signal values. The first time grid may in this case be for example a fixed time grid with definitely predetermined time intervals between the individual sampling times. It is also possible in addition to vary the first time grid, that is to say change the time intervals between two successive samplings of the input signal. The adaptation of the first time grid may in this case be prescribed for example by an external control device (not represented). The boundary conditions for the choice of the first time grid with respect to the second time grid for the further processing explained in more detail below are also explained in still more detail further below. The sampled signal values u(tₖ) are then provided together with the points in time tₖ of the sampling to a differentiating device 20. The differentiating device 20 receives the sampled signal values u(tₖ). If appropriate, the differentiating device 20 may in this case store a prescribed number of sampled signal values u(tₖ). In this way, the differentiating device 20 can also revert to previous sampled signal values u(tₖ). For example, a predetermined number of sampled signal values u(tₖ) may be buffer-stored in a cyclical memory. However, any other desired type of buffer storage of signal values is also additionally possible. If the signal values u(t) at the input of the input device 10 are sampled with a definitely prescribed sampling rate, the differentiating device 20 can, with knowledge of this definitely prescribed sampling rate, also infer the time intervals of the individual detected signal values u(tₖ). In this case, the time differences between two successive sampled signal values can be kept stored as fixed values in the differentiating device 20. Alternatively, in particular in the case of a variable sampling grid for the sampling of the input signal at the detecting device 10, the respective points in time tₖ at which the signal values u(tₖ) have been sampled can also be transmitted to the differentiating device 20. In this case, the sampling times tₖ together with the respective sampled signal values u(tₖ) can be stored in a memory of the differentiating device 20. For differentiating the sampled signal values, the differentiating device 20 may in this case form a difference between two sampled signal values and divide this difference by the difference between the sampling times. In this way, the differentiating device 20 calculates a difference quotient that is independent of the sampling time grid.

This difference quotient may subsequently be passed on to the processing device 30 in a second time grid that is required for the further processing in the processing device 30. The input variable at the input of the detecting device 10 does not have to be sampled significantly faster than the second time grid of the processing device 30. Rather, it only has to be ensured that as far as possible an update, that is to say a sampling by the detecting device 10, takes place between two points in time of the second time grid.

After the changeover of the difference quotient formed in the differentiating device 20 into the second time grid of the processing device 30, the further processing of the difference quotient takes place in the second time grid of the processing device 30. This further processing of the difference quotient by the processing device 30 may for example comprise a filtering, in particular a low-pass filtering. For example, the processing device 30 may comprise a PTn element for the filtering of the angle signal. However, any desired other processing steps for the filtering of the angle signal, in particular of the difference quotient of the angle signal, are similarly also additionally possible. Since the output of the difference quotient from the differentiating device 20 takes place with the constant increment of the second time grid, any desired approaches of a linear, discrete-time control technology can be used for the further processing.

FIG. 3 shows a schematic representation of a method for processing an angle signal as used as a basis for an embodiment. In a first step S1, first an angle signal is detected with a first sampling rate in a first time grid. Subsequently, in step S2, the detected angle signal is differentiated in the first time grid. For this purpose, as already described above, the difference quotient of the angle signal and the sampling times is formed.

In step S3, the differentiated angle signal is output in a second time grid and, in step S4, the output differentiated angle signal, that is to say the difference quotient of the angle signal, is processed in the second time grid.

As already described above, it should in this case be ensured that at least one update of the sampled angle signal takes place between two points in time in the computation grid of the processing of the difference quotient.

To sum up, the present invention relates to a signal processing of signals with simultaneous conversion of the processing time grid. To this end, a signal is detected or provided in a first time grid. After forming the difference quotient in the first time grid, output of the difference quotient takes place in a second time grid, in which the further processing of the signal, in particular of the difference quotient, takes place. The signal processing may be applied in particular to angle signals.

1. A device for processing a signal, the device comprising:
a detecting device, which is designed to detect a signal with a first sampling rate in a first time grid;
a differentiating device, which is designed to differentiate the detected signal in the first time grid and output it in a second time grid; and
a processing device, which is designed to process the differentiated signal in the second time grid,
the time intervals in the first time grid being smaller than the time intervals in the second time grid.

2. The device as claimed in claim 1, the processing device comprising a PT1 element.

3. The device as claimed in claim 1, the differentiating device being designed to subtract a value of a signal detected by the detecting device from a value that has previously been detected by the detecting device, and to divide the differences by the time interval of the two detected signals.

4. The device as claimed in claim 1, the differentiating device being designed to output the differentiated signal in the second time grid to the processing device.

5. The device as claimed in claim 1, the first sampling rate in the first time grid being variable.

6. A drive system, comprising:
an electrical machine, which is coupled to a drive shaft;
a rotational angle sensor, which is coupled to the drive shaft and is designed to provide a signal corresponding to the angular position of the drive shaft; and
a device for processing a signal having
a detecting device, which is designed to detect a signal with a first sampling rate in a first time grid;
a differentiating device, which is designed to differentiate the detected signal in the first time grid and output it in a second time grid; and
a processing device, which is designed to process the differentiated signal in the second time grid,
the time intervals in the first time grid being smaller than the time intervals in the second time grid.

7. A method for processing a signal, the method comprising:
detecting a signal with a first sampling rate in a first time grid;
differentiating the detected signal in the first time grid;
outputting the differentiated signal in a second time grid; and
processing the output differentiated signal in the second time grid,
the time intervals in the first time grid being smaller than the time intervals in the second time grid.

8. The method as claimed in claim 7, wherein processing the differentiated signal comprises low-pass filtering.
